(19) United States
(12) Patent Application Publication
(10) Pub. No.: US 2024/0401955 A1
(43) Pub. Date: Dec. 5, 2024

(54) METHOD AND SYSTEM FOR PROVIDING RECOMMENDATIONS FOR INDOOR NAVIGATION

(71) Applicant: HCL Technologies Limited, New Delhi (IN)

(72) Inventors: SIMY CHACKO, Chennai (IN); VENKATESH SHANKAR, Chennai (IN); PAWAN JIYALAL YADAV, Chennai (IN); ABHISHEK VISHWANATH DALVI, Chennai (IN)

(21) Appl. No.: 18/384,399

(22) Filed: Oct. 27, 2023

(30) Foreign Application Priority Data
May 31, 2023 (IN) 202311037592

(51) Int. Cl. G01C 21/20; G06T 7/246; G06T 7/292; G06T 7/73

(52) U.S. Cl. CPC G01C 21/206; G06T 7/248; G06T 7/292; G06T 7/74; G06T 2200/24; G06T 2207/20092; G06T 2207/30196

(57) ABSTRACT

The invention relates to method and system for identifying a current location of a user in a closed premises. The method includes capturing user information associated with the user and object information associated with one or more static objects in proximity to the user, when the user and the one or more static objects are within a Field of View (FOV) of at least one camera; comparing the user information with historical user information corresponding a plurality of users visited the closed premises, and the object information with historical object information corresponding to a plurality of static objects within the closed premises; and identifying the current location of the user within the closed premises based on the comparing.

### TECHNICAL FIELD

Generally, the invention relates to navigation systems. More specifically, the invention relates to a system and method for identifying a current location of a user in a closed premises and providing recommendations for indoor navigation.

### BACKGROUND

Today, navigation systems are generally used to determine locations, directions, and routes to destinations. One of the most common navigation systems is Global Positioning System (GPS) used for outdoor navigation. The GPS depends on satellite signals and external sources, to determine the locations. However, the GPS and other similar outdoor positioning systems face difficulties when it comes to indoor navigation. In case of the indoor navigation, signal interference occurs due to obstacles (such as buildings, walls, and ceilings), which makes it difficult for GPS receivers to correctly determine the locations indoors. Indoor environments can also be complicated and dynamic, with changing layouts, furniture, and other objects that can interfere with GPS signals. In addition, the GPS signals may bounce off surfaces and create multipath errors, which can further distort location accuracy.

Currently, various existing indoor navigation systems are available, such as an Indoor Positioning System (IPS). The IPS uses technologies including Wireless Fidelity (Wi-Fi), Bluetooth, Visible Light Communication (VLC), Magnetic Positioning, Radio Frequency Identification and Detection (RFID), and sensors. The existing IPS lacks in terms of accuracy, cost, privacy, user experience, and coverage. The signal interference due to the obstacles such as the walls or other obstructions makes the IPS unreliable and inaccurate. In addition, the IPS relies on the availability of Wi-Fi or Bluetooth, that is not available all the time in all areas.

The present invention is directed to overcome one or more limitations stated above or any other limitations associated with the known arts.

### SUMMARY

In one embodiment, a method for identifying a current location of a user in a closed premises is disclosed. The method may include capturing user information associated with the user and object information associated with one or more static objects in proximity to the user, when the user and the one or more static objects are within a Field of View (FOV) of at least one camera. The user information may include primary user data and secondary user data. The primary user data may be stored in a form of hash value. The method may further include comparing the user information with historical user information corresponding a plurality of users visited the closed premises, and the object information with historical object information corresponding to a plurality of static objects within the closed premises. The method may further include identifying the current location of the user within the closed premises based on the comparing.

In another embodiment, a system for identifying a current location of a user in a closed premises is disclosed. The system may include a processor and a memory communicatively coupled to the processor. The memory may store processor-executable instructions, which on execution, may further cause the processor to capture user information associated with the user and object information associated with one or more static objects in proximity to the user, when the user and the one or more static objects are within a Field of View (FOV) of at least one camera. The user information may include primary user data and secondary user data. The primary user data may be stored in a form of hash value. The processor-executable instructions, on execution, may further cause the processor to compare the user information with historical user information corresponding a plurality of users visited the closed premises, and the object information with historical object information corresponding to a plurality of static objects within the closed premises. The processor-executable instructions, on execution, may further cause the processor to identify the current location of the user within the closed premises based on the comparing.

In yet another embodiment, a non-transitory computer-readable medium storing computer-executable instructions for identifying a current location of a user in a closed premises is disclosed. The stored instructions, when executed by a processor, may cause the processor to perform operations including capturing user information associated with the user and object information associated with one or more static objects in proximity to the user, when the user and the one or more static objects are within a Field of View (FOV) of at least one camera. The user information may include primary user data and secondary user data. The primary user data may be stored in a form of hash value. The operations may further include comparing the user information with historical user information corresponding a plurality of users visited the closed premises, and the object information with historical object information corresponding to a plurality of static objects within the closed premises. The operations may further include identifying the current location of the user within the closed premises based on the comparing.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a block diagram of an exemplary system in a network environment for identifying a current location of a user in a closed premises, in accordance with some embodiments of the present disclosure.

FIG. 2 illustrates a flow diagram of an exemplary process for identifying a current location of a user in a closed premises, in accordance with some embodiments of the present disclosure.

FIG. 3 illustrates a flow diagram of an exemplary process for determining a route for indoor navigation for a user, in accordance with some embodiments of the present disclosure.

FIG. 4 illustrates a flow diagram of an exemplary process for identifying a type of a user, in accordance with some embodiments of the present disclosure.

FIG. 5 illustrates an exemplary scenario of a user entering a closed premises, in accordance with some embodiments of the present disclosure.

FIG. 6 illustrates an exemplary mobile device rendering a login page of an application, in accordance with some embodiments of the present disclosure.

FIGS. 7A-7B illustrate an exemplary mobile device rendering an optimal route on a map of indoor premises, in accordance with some embodiments of the present disclosure.

FIG. 8 illustrates an exemplary mobile device rendering a new optimal route on a map of indoor premises is illustrated, in accordance with some embodiments of the present disclosure.

FIG. 9 is a block diagram of an exemplary computer system for implementing embodiments consistent with the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions). Software and firmware can be stored on computer-readable storage media. Some other processes can be implemented using analog circuitry, as is well known to one of ordinary skill in the art. Additionally, memory or other storage, as well as communication components, may be employed in embodiments of the invention.

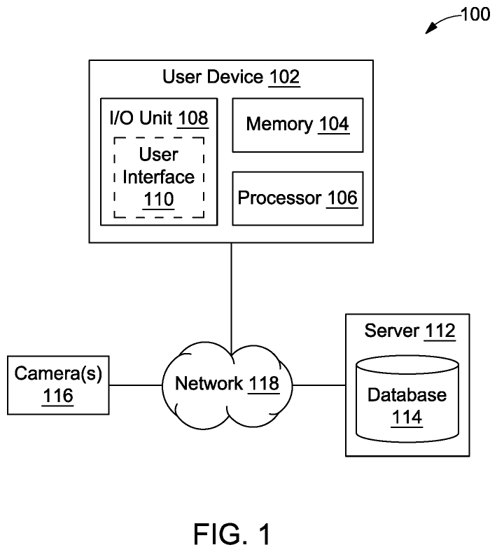

Referring now to FIG. 1, an exemplary system 100 in a network environment for identifying a current location of a user in a closed premises is illustrated, in accordance with some embodiments of the present disclosure. The system 100 may automatically identify the current location of the user when the user enters in the closed premises. The system 100 may include a user device 102 that may be carried by the user. Examples of the user device 102 may include, but are not limited to a smartphone, a laptop, a computer, a desktop, a mobile phone, a tablet, a smart watch, smart-band, a smart wearable, or the like. The user may be able to use an application on the user device 102. The application may be a mobile application, or a web application.

The user device 102 may include a memory 104, a processor 106, and an input/output (I/O) unit 108. The I/O unit 108 may further include a user interface 110. The user may interact with the user device 102 and vice versa through the I/O unit 108. By way of an example, the user interface 110 may be used to output or display data (such as, for displaying a login page of the application, an optimal route, a notification, a location, an updated route, and the like), to the user. The updated route may correspond to a new route. For example, the new route may be generated when the user diverts from the optimal route. By way of another example, the user interface 110 may be used by the user to provide inputs to the user device 102.

For example, for providing details of a destination location where the user wants to reach, user details for sign up, and the like. In some embodiments, upon a successful user authentication, the user may provide a user input related to the destination location to the user device 102 through the user interface 110 of the I/O unit 108. Thus, for example, in some embodiments, the user device 102 may ingest information provided by the user via the user interface 110. Further, for example, in some embodiments, the user device 102 may render results to the user via the user interface 110.

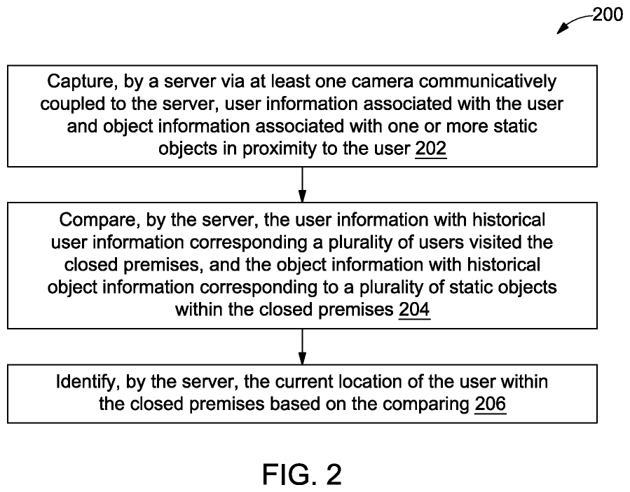

The memory 104 may store instructions that, when executed by the processors 106, may cause the processors 106 to perform one or more operations. As will be described in greater detail in conjunction with FIG. 2 to FIG. 9, the processor 106 in conjunction with the memory 104 may process details provided by the user to a server 112 via a communication network 118, results of analysis performed by the server 112 (such as the optimal route, current location of the user, recommendations, updated route etc.) to the user, and the like.

The memory 104 may also store various data (e.g., user information, routes, locations etc.) that may be captured, processed, and/or required by the user device 102. The memory 104 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.)

Further, the user device 102 may interact with the server 112 or camera(s) 116 via the communication network 118 for sending and receiving various data. The communication network 118, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

The server 112 may further include a database 114, which may store information such as, object information, user information, hash values, historical scenarios, location coordinate tags, routes etc. The camera(s) 116 may be assigned with the location coordinate tags of static objects. In particular, the location coordinate tags may be assigned to corresponding cameras for each location of a plurality of locations within the closed premises. For example, consider that at one location there are two cameras and three static objects (a sofa, a pillar, and a table). In that case, each of the two cameras may be assigned with the location coordinate tags of the three objects.

Further, the camera(s) 116 may capture the user information and the object information associated with one or more static objects in proximity to the user, when the user and the one or more static objects are within a Field of View (FOV) of the camera(s). It should be noted that the terms objects and the static objects are used interchangeably in the present disclosure. The user information may include primary user data and secondary user data. The information captured using the camera(s) 116 may be transmitted to the server 112 via the network 118. It should be noted that the server 112 may be an application server associated with the application running on the user device 102.

Further, the server 112 may compare the user information with historical user information corresponding a plurality of users visited the closed premises, and the object information with historical object information corresponding to a plurality of static objects within the closed premises. Based on the comparison, the server 112 may identify the current location of the user within the closed premises. In some embodiments, the server 112 may determine a hash value corresponding to the primary user data. The hash value may be compared with a plurality of historical hash values stored in the database 114 corresponding to primary user data of the plurality of users visited the closed premises. In case the hash value is different from each of the plurality of historical hash values, the hash value may be stored in the database 114 and the user may be considered as a new user. Alternatively, when the hash value is equivalent to at least one hash value of the plurality of historical hash values, the user may be considered as an existing user.

Additionally, in some embodiments, the server 112 may determine an optimal route from a plurality of routes based on the current location of the user, the destination location, and the user information. Subsequently, the server 112 may interact with the user device 102 via the communication network 118 for providing recommendations to the user. Further, the user device 102 may render the optimal route and associated recommendations to the user for navigating inside the closed premises to reach the destination location based on the optimal route, via the user interface 110.

When the user starts moving on the optimal route, motion of the user may be continuously monitored via each of a set of cameras (of the camera(s) 116) along the optimal route. This information is transmitted to the server 112. Further, the server 112 may validate whether the motion of the user is on the optimal route. In case the validation is unsuccessful, the server 112 may determine a new optimal route to the destination which may be transmitted to the user device 102. The new optimal route may be rendered to the user via the user interface 110.

It should be noted that the system 100 and associated server 112 may be implemented in programmable hardware devices such as programmable gate arrays, programmable array logic, programmable logic devices, or the like. Alternatively, the system 100 and the associated server 112 may be implemented in software for execution by various types of processors. An identified engine/module of executable code may, for instance, include one or more physical or logical blocks of computer instructions which may, for instance, be organized as a component, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for identifying the current location of the user in the closed premises. For example, the exemplary system 100 and the associated server 112 may identify the current location of the user, by the process discussed herein. In particular, as will be appreciated by those of ordinary skill in the art, control logic and/or automated routines for performing the techniques and steps described herein may be implemented by the system 100 and the server 112 either by hardware, software, or combinations of hardware and software. For example, suitable code may be accessed and executed by the one or more processors on system 100 and the server 112 to perform some or all of the techniques described herein. Similarly, application specific integrated circuits (ASICs) configured to perform some, or all the processes described herein may be included in the one or more processors on the system 100 and associated server 112.

Referring now to FIG. 2, an exemplary process for identifying a current location of a user in a closed premises is depicted via a flow diagram 200, in accordance with some embodiments of the present disclosure. Each step of the process may be performed by a server (similar to the server 112). FIG. 2 is explained in conjunction with FIG. 1.

At step 202, user information associated with the user and object information associated with one or more static objects in proximity to the user may be captured. The user information may include primary user data and secondary user data. The primary user data may correspond to a plurality of constant user attributes and the secondary user data may correspond to a plurality of variable user attributes. For example, the primary data may include, but are not limited to, an image of the user, a face image of the user, a face shape of the user, a face color of the user, an eye color of the user, other facial features, a height of the user. Further, for example, the secondary data may include, but is not limited to, a color of user's shirt, user's shoes, and user's hair style.

The primary user data may be stored in a form of hash value in a database (such as the database 114) of the server. Examples of the one or more static objects may include, but are not limited to, a pillar, a bed, a table, a sofa, and a corner. The user information and the object information may be captured through at least one camera (for example, the camera(s) 116) communicatively coupled to the server. It should be noted that at least one camera may be able to capture the user information and the object information when the user and the one or more static objects are within a Field of View (FOV) of the at least one camera. The location of the user may be identified based on only the secondary user data when the at least one camera is not able to capture the primary user data completely. For example, when the camera captures the user (sitting on a chair) from back-side.

By way of an example, consider a scenario where a patient enters a reception area of a hospital (i.e., the closed premises). The hospital may include different buildings, wards, rooms, conference rooms, waiting areas, operating theatres, and the like. The reception area includes two cameras, and static objects ((for example, a total of five three-seater fixed chairs, a banner (including different doctors' names and their specializations), a reception desk, and a computer on the reception desk)). With reference to a current location of the patient, all the static objects are in proximity to the patient. Further, each of the two cameras captures the patient, and one or more of the static objects within the FoV of the each of the two cameras. In other words, the two cameras within the reception area collectively may capture patient information and object information (i.e., information of the total of five three-seater fixed chairs, the banner, the reception desk, and the computer on the reception desk). The five three-seater fixed chairs may be arranged in a row-wise manner. In other words, there are a total of five rows, each having a three-seater chair. The banner may hang on a wall behind the fifth row of the three-seater chair. Now, when the user sits on a seat of a three seater chair of a fourth row, only one camera of the two cameras may be able to capture the patient. This means the patient is within the FoV of only one camera. Also, this one camera may capture all the five rows of the three-seater chairs and the banner on the wall, as these static objects are in proximity to the patient.

At step 204, the user information may be compared with historical user information corresponding a plurality of users visited the closed premises, and the object information may be compared with historical object information corresponding to a plurality of static objects within the closed premises. It should be noted that location coordinate tags of static objects may be assigned to corresponding cameras for each location of a plurality of locations within the closed premises. With regards to the previous example, the location coordinate tags of each of the five three-seater fixed chairs, the banner, the reception desk, and the computer on the reception desk may be assigned to the one or more of the two cameras. For example, the location coordinate tags of the banner and each of the five three-seater chairs may be assigned to a first camera. The location coordinate tags of the reception desk and the computer may be assigned to a second camera. The patient information and the object information (i.e., information of the total of five three-seater fixed chairs and the banner) may be compared with historical user information corresponding a plurality of users visited the hospital and historical object information corresponding to a plurality of static objects within the hospital, respectively.

Thereafter, at step 206, the current location of the user within the closed premises may be identified based on the comparison. With regards to the exemplary scenario, based on the comparison, the current location of the patient may be determined within the reception area.

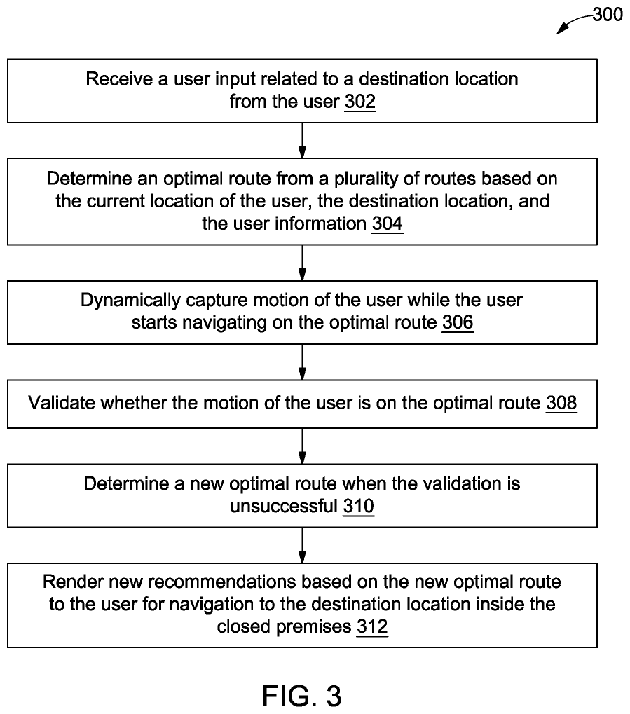

Referring now to FIG. 3, an exemplary process for determining a route for indoor navigation for the user is depicted via a flowchart 300, in accordance with some embodiments of the present disclosure. FIG. 3 is explained in conjunction with FIGS. 1-2. Each step of the process may be performed through a server (same as the server 112), and a user device (such as the user device 102).

At step 302, a user input related to a destination location may be received from the user, upon a successful user authentication. When the user enters the closed premises, the user may login to an application associated with the server through the user device. To login to the application, the user may need to provide correct user credentials. The user credentials may be an email address, a user ID, a username, a phone number, a password, a passcode, a passkey, an answer to a question, and/or a passphrase. Once the user successfully logs into the application by providing the correct user credentials, the user may be able to fill the destination location of interest. In some embodiments, the user may be provided with the login credentials which may be valid for a predefined period and get expired after expiration of the predefined period. After expiration, the user may not be able to login with the provided login credentials and need to ask for new ones.

At step 304, an optimal route from a plurality of routes may be determined. The optimal route, for example, may be shortest route determined to reach the destination location. The optimal route may be determined based on a current location of the user, the destination location, and the user information. Capturing of the user information and determination of the current location of the user has already been explained in FIG. 2. In some embodiments, the user may also fill an approximate current location. In that case, this information may also be used for determining the exact current location and the optimal route.

At step 306, recommendations may be provided to the user for indoor navigation or navigating inside the closed premises, to reach the destination location. The recommendations may be based on the optimal route. For example, the recommendations may be “go straight”, “take a left turn”, “take a right turn”, or the like. The recommendations may be rendered to the user on the user device.

Thereafter, at step 308, when the user may start navigating on the optimal route, a motion of the user may be captured dynamically. It should be noted that the motion of the user during the navigation may be captured via each of a set of cameras along the optimal route. At step 310, whether the motion of the user is on the optimal route may be validated. Further, at step 312, a new optimal route may be determined when the validation is unsuccessful. At step 314, new recommendations based on the new optimal route may be rendered to the user for navigation to the destination location inside the closed premises.

With reference to the previous example of the hospital and patient, after sitting, the patient may login to the application through a mobile phone by providing correct user credentials as “ABCD” as username and “@Xyz123” as password. Furthermore, the user may fill a destination location inside the hospital as “ward-3”. Thereafter, the optimal route to the destination location “ward-3” may be determined for the patient based on the patient's location (i.e., the current location) within the reception area, ward-3 (i.e., the destination location), and the patient's information. Further, the recommendations may be provided to the patient for reaching the ward-3 based on the optimal route. For example, the optimal route may have various enroute cameras and these enroute cameras may continuously monitor motion of the patient while moving on the optimal route. When the patient diverts from the optimal route, this condition may be considered as invalidation of motion of the patient on the optimal route. In such a case, a new optimal route to reach the ward-3 may be generated for the patient. Now, the patient may follow the recommendations provided based on the new optimal route to reach the ward-3.

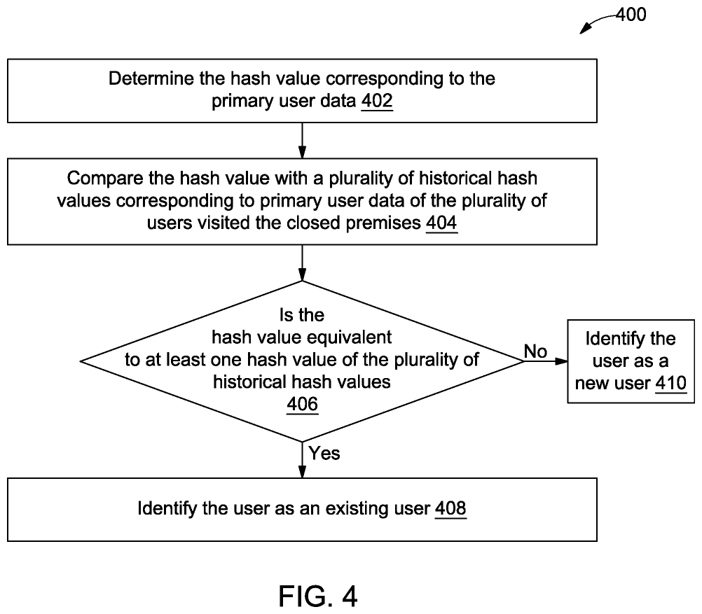

Referring now to FIG. 4, an exemplary process for identifying a type of a user (i.e., an existing user or a new user) is depicted via a flowchart 400, in accordance with some embodiments of the present disclosure. FIG. 4 is explained in conjunction with FIGS. 1-3. Each step of the process may be performed through a server (same as the server 112).

At step 402, the hash value corresponding to the primary user data may be determined. At step 404, the hash value may be compared with a plurality of historical hash values corresponding to the primary user data of the plurality of users who visited the closed premises. At step 406, a condition of the hash value equivalent to at least one hash value of the plurality of historical hash value may be checked. Further, in case the condition is true, and the hash value is equivalent to at least one hash value of the plurality of historical hash values, at step 408, the user may be identified as an existing user. Otherwise, when the condition is false and the hash value is different from each of the plurality of historical hash values, at step 410, the user may be identified as a new user.

In continuation to the previous example, the hash value corresponding to the primary patient data may be “DFCD 700D3”. Further, the database of the server may include the hash values corresponding to the visitors who visited the hospital, such as the plurality of hash values “4604 24D009”, “9158 B9314”, “HPKM 12563”, “P42M 99841”, and “263C EA941”. In such a case, the patient may be considered as a new visitor as the hash value (i.e., “DFCD 700D3”) corresponding to the primary patient data is not equivalent to any of the hash values (i.e., “4604 24D009”, “9158 B9314”, “HPKM 12563”, “P42M 99841”, and “263C EA941”). In other words, the hash value “DFCD 700D3” is different from each of the “4604 24D009”, “9158 B914”, “HPKM 2563”, “P42M 9981”, and “263C EA941”. Further, the hash value “DFCD 700D3” may be saved in the database, which means the database may be updated with the hash value “DFCD 700D3”. Now, the updated database includes the hash values “DFCD 700D3”, “4604 24D009”, “9158 B9314”, “HPKM 12563”, “P42M 99841”, and “263C EA941”.

Further, when the same patient visits the hospital again after some days, the hash value corresponding to the primary patient data may be determined again as “DFCD 700D3”, that may be checked against each hash value within the updated database. This time the hash value corresponding to the primary patient data may be found within the database. In such a case, the patient may be considered as the existing patient who previously visited the hospital.

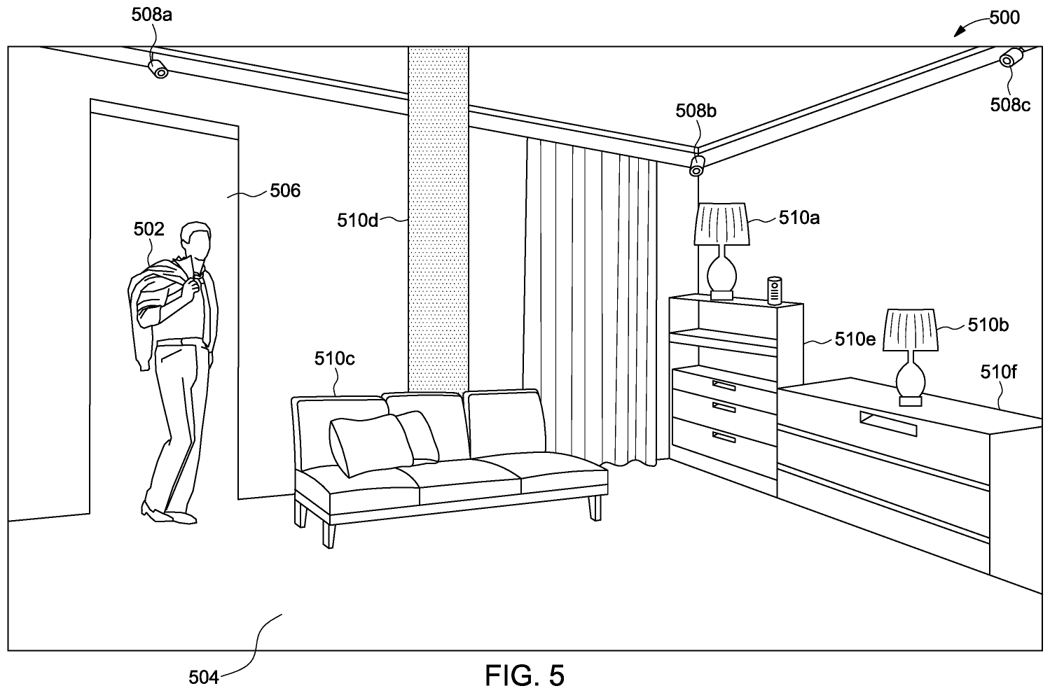

Referring now to FIG. 5, an exemplary scenario 500 of a user 502 entering a closed premises is illustrated, in accordance with some embodiments of the present invention. FIG. 5 is explained in conjunction with FIGS. 1-4. By way of an example, consider that the user 502 enters a location 504 within the closed premises. Examples of the closed premises may include, but are not limited to, a hospital, any healthcare facility, gated societies, educational buildings, university buildings, co-working spaces, offices, shopping complexes, airports, cruise ships, and railway stations. The user 502 may enter the location 504 from a door 506. The location 504 may include three cameras (for example, a camera 508a, a camera 508b, and a camera 508c). Further, the location may include static objects (for example, the door 506, a lamp 510a, a lamp 510b, a sofa 510c, a pillar 510d, a drawer unit 510e, and a drawer unit 510f). The cameras 508a, 508b, and 508c may be tagged with location coordinate tags of one or more of the lamp 510a, the lamp 510b, the sofa 510c, the pillar 510d, the drawer unit 510e, and the drawer unit 510f. As will be appreciated to the person skilled in the art, the camera 508c may be able to capture user information of the user 502 (i.e., primary user data and secondary user data), and object information of the door 506, the sofa 510c, and the pillar 510d (in proximity to the user 502). The primary data may be facial features of the user 502 and height of the user 502, and the secondary user data may be hair style of the user 502, color and style of cloths, and the like. Further, based on the user information and the object information, the current location of the user 502 may be determined as “Gate No. 1, Reception”.

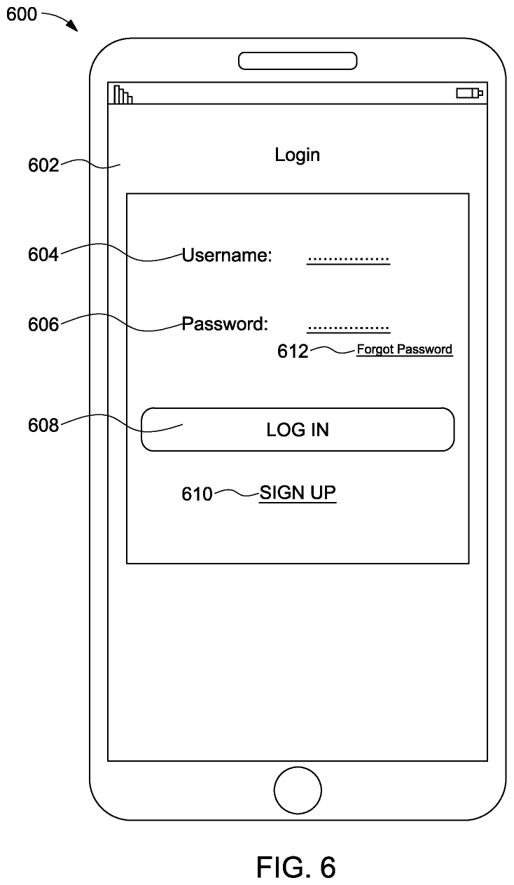

Further, after entering the location 504, the user 502 may open an application hosted on a server (same as the server 112) via a mobile phone (i.e., the user device 102). A login page may be rendered to the user 502 on the mobile phone. An exemplary login page is illustrated further in conjunction with FIG. 6. Now the user 502 has to provide user credentials to login to the application. For example, the user may have provided a username as “ABCD” and a password as “@1234XYZ”. In some embodiments, the user may be provided with the login credentials which may be valid for a predefined period and get expired after expiration of the predefined period. After expiration, the user may not be able to login using the provided login credentials and need to ask for new ones.

Further, upon successful user authentication, the user 502 may be navigated to a page where the user 502 may fill a destination location of interest. In some embodiments, when the user 502 provides incorrect details, the user 502 may be notified that details (i.e., the user credentials) entered are incorrect and the user should try it again. When the user authentication is successful, in some embodiments, the user 502 may also fill the approximate current location. For example, the user 502 may fill the approximate current location as “Reception” and the destination location as “Room No. 5, School Building”.

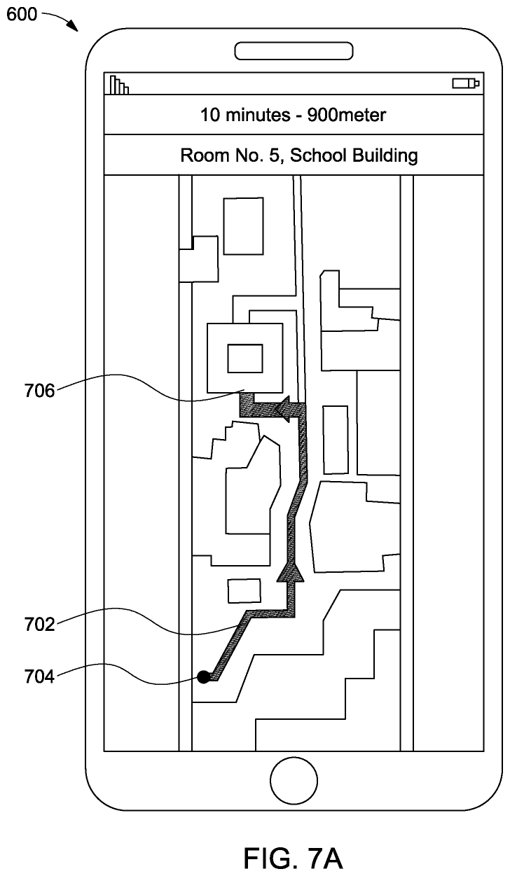

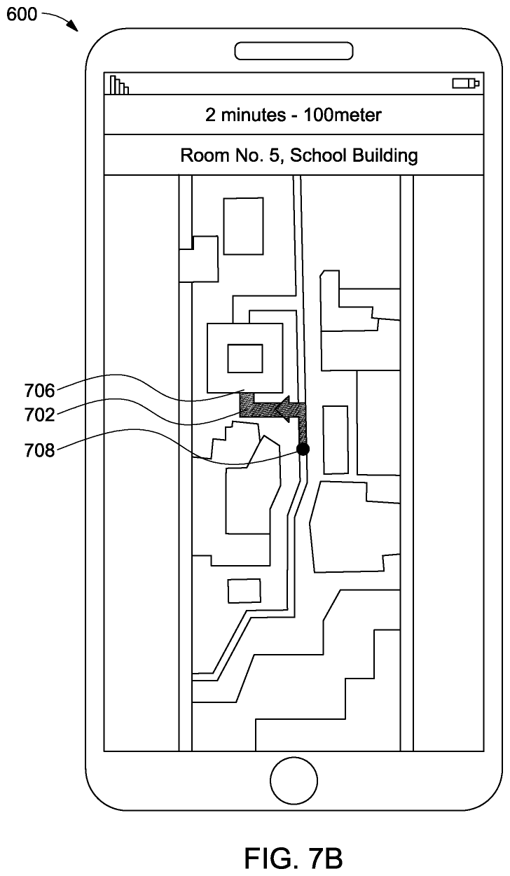

The server may determine the exact current location of the user 502. Further, an optimal route may be generated by the server based on the user information, the current location, and the destination location. The user 502 may take an action for navigation based on the optimal route. When the user 502 moves towards the destination location following the optimal route, the user 502 may be provided with recommendations through the mobile phone. For example, the recommendations may be “move straight for 50 meters, take a right turn in 100 meters, take a left turn in 150 meters, walk for one minute to stairs, and the like”. The recommendations may be provided through an audio, and/or a text. In case the user 502 diverts from the optimal route, a new optimal route may be determined within a predefined period. Alternatively, in some embodiments, the user 502 may also provide inputs for generating the new optimal route. The processes of determining the current location, identifying the type of a user (i.e., a new user or an existing user), determining the optimal route are same as the processes discussed in FIGS. 2-4. Further, the exemplary scenarios with respect to the optimal route and the new optimal routes are illustrated and explained in FIGS. 6-7.

Referring now to FIG. 6, an exemplary mobile device 600 rendering a login page 602 of an application to the user 502 is illustrated, in accordance with some embodiments of the present invention. FIG. 6 is explained in conjunction with FIGS. 1-5. The login page 602 includes components including a username 604, and a password 606. For example, the user 502 may fill “ABCD” corresponding to the component username 604 and “@Xyz123” corresponding to the component password 606. The login page 602 may further include a login button 608. The user 502 may click on the login button 608 after filling details (i.e., “ABCD” and “@Xyz123”) corresponding to the username 604 and the password 606. This action of the user 502 may navigate the user 502 to a new page where the user 502 may provide a destination location of interest.

Also, the login page 602 may include a signup link 610. By clicking on the signup link 610 the user 502 may be navigated to a signup page where the user 502 may have to provide required details for creating an account. By way of an example, the user 502 may be required to create the account, when the user 502 is the new user or first-time visitor of the closed premise. Additionally, the login page 602 includes a hyperlink Forgot Password 612. In some embodiments, the user 502 may click on the hyperlink Forgot Password 612, when the user 502 fails to remember the details corresponding to the password. By clicking on the Forgot Password 612, the user 502 may be navigated to a reset page where the user may have to provide a registered mobile number or a register email ID for regenerating a new password.

In some embodiments, after filling the registered mobile number or the register email ID, a One Time Password (OTP) may be sent to the registered mobile number or the register email ID. Alternatively, in some embodiment, a link to change the password may be sent to the registered mobile number or the register email ID. Further, the user 502 may fill the OTP to login to the application, or once the password is changed, the user may login to the application by providing the details corresponding to the username 604 and the password 606 (i.e., the new password).

Referring now to FIGS. 7A-7B, the exemplary mobile device 600 rendering an optimal route 702 on a map of indoor premises is illustrated, in accordance with some embodiments of the present invention. FIGS. 7A-7B are explained in conjunction with FIGS. 1-6. With reference to the FIG. 6, once the user 502 fills the destination location (for example, “Room No. 5, School Building”), the optimal route 702 may be generated based on the current location of the user 502, the destination location provided by the user 502, and the user 502 information captured by the camera 508c. The determination of the current location of the user 502 has already been explained in detail. Further, the optimal route 702 on the map of the indoor premises may be rendered to the user 502 on the mobile device 600. Time (such as 10 minutes in FIG. 7A and 2 minutes in FIG. 7B) to reach the destination location 706 and distance (such as 900 meters in FIG. 7A, and 100 meters in FIG. 7B) to the destination location 706 may always be shown at the top.

FIG. 7A illustrates the optimal route 702 when the user 502 is at a start location 704 (i.e., the current location determined for generating the optimal route 702) and has not yet started moving on the optimal route 702. Further, the optimal route 702 may include a destination location 706 (i.e., “Room No. 5, School Building”). Further, FIG. 7B illustrates the optimal route 702 when the user 502 reaches a location 708 following directions on the optimal route 702. In other words, the current location of the user 502 may be shifted from the start location 704 to the location 708. Directions on the optimal route 702 are indicated with the help of arrows.

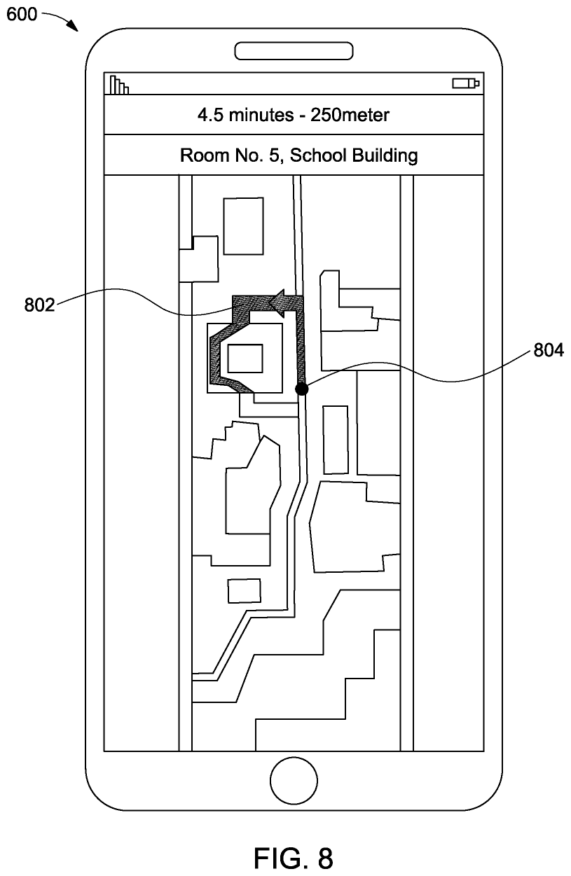

Referring now to FIG. 8, the exemplary mobile device 600 rendering a new optimal route on the map of the indoor premises is illustrated, in accordance with some embodiments of the present invention. FIG. 8 is explained in conjunction with FIGS. 1-7A and 7B. Time (such as 4.5 minutes) to reach the destination location 706 and distance (such as 250 meters) to the destination location may always be shown at the top. When the user 502 diverts from the optimal route 702, a new optimal route 802 may be generated and rendered to the user 502. By way example, as illustrated in FIG. 8, the user 502 may have mistakenly moved forward instead of taking a left turn. Therefore, the new optimal route 802 may be rendered to the user 502. Now, the user 502 may have reached a location 804 or the current location of the user 502 is the location 804. Once the new optimal route 802 is rendered, the user 502 may follow the new optimal route 802 to reach the destination location 706.

By way of an example, consider a scenario where a co-working space includes three buildings, such as a block ‘A’, a block ‘B’, and a block ‘C’. An interview of a candidate (i.e., a user) is scheduled in an Office ‘XYZ’. The office ‘XYZ’ is within the block ‘B’ of the co-working space. The candidate may want to visit the office ‘XYZ’. It should be noted that the candidate may be visiting this co-working space for the first time. Which means the candidate may be treated as a new user by a system (same as the system 100). In one example, once the candidate enters a main gate of the co-working space, cameras at an entrance may capture the candidate and objects in proximity to the candidate.

The candidate may be provided with temporary credentials which may be used to login to the application through a mobile phone (i.e., the user device 600). The candidate may login to the application using the credentials, and provide the destination location as “Block B, office “XYZ”. In some embodiment, when the candidate is the new user, the candidate may be required to signup with the application through his mobile device. Once the candidate signup with the application, the candidate may login to the application using authentication credentials defined during signup process. Further, the system may generate an optimal route for the candidate and render the optimal route on the mobile phone to the candidate. When the candidate follows the route, the application may also provide recommendations such as “take a right turn”, “walk 3 minutes upstairs”, “take a left turn”, and the like. Further, if the candidate take a right turn instead of a left turn, the application may generate a new optimal path for the candidate.

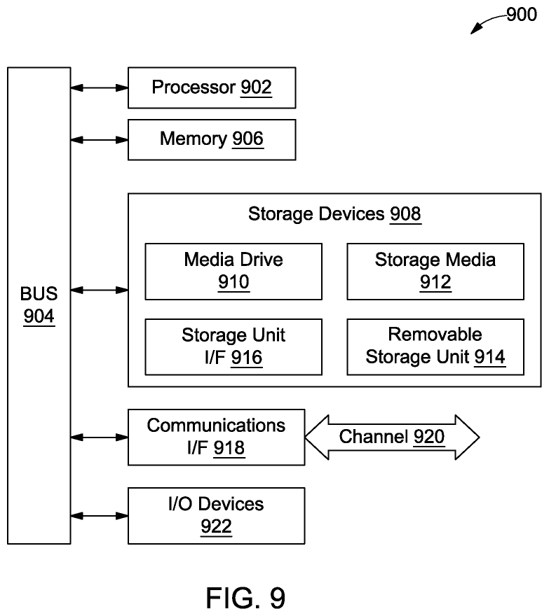

The disclosed methods and systems may be implemented on a conventional or a general-purpose computer system, such as a personal computer (PC) or server computer. Referring now to FIG. 9, an exemplary computing system 900 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 900 may represent, for example, a user device such as a desktop, a laptop, a mobile phone, personal entertainment device, DVR, and so on, or any other type of special or general-purpose computing device as may be desirable or appropriate for a given application or environment. The computing system 900 may include one or more processors, such as a processor 902 that may be implemented using a general or special purpose processing engine such as, for example, a microprocessor, microcontroller or other control logic. In this example, the processor 902 is connected to a bus 904 or other communication medium. In some embodiments, the processor 902 may be an AI processor, which may be implemented as a Tensor Processing Unit (TPU), or a graphical processor unit, or a custom programmable solution Field-Programmable Gate Array (FPGA).

The computing system 900 may also include a memory 906 (main memory), for example, Random Access Memory (RAM) or other dynamic memory, for storing information and instructions to be executed by the processor 902. The memory 906 also may be used for storing temporary variables or other intermediate information during execution of instructions to be executed by the processor 902. The computing system 900 may likewise include a read only memory (“ROM”) or other static storage device coupled to bus 904 for storing static information and instructions for the processor 902.

The computing system 900 may also include a storage device 908, which may include, for example, a media drives 905 and a removable storage interface. The media drive 910 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 912 may include, for example, a hard disk, magnetic tape, flash drive, or other fixed or removable medium that is read by and written to by the media drive 910. As these examples illustrate, the storage media 912 may include a computer-readable storage medium having stored there in particular computer software or data.

In alternative embodiments, the storage devices 908 may include other similar instrumentalities for allowing computer programs or other instructions or data to be loaded into the computing system 900. Such instrumentalities may include, for example, a removable storage unit 914 and a storage unit interface 916, such as a program cartridge and cartridge interface, a removable memory (for example, a flash memory or other removable memory module) and memory slot, and other removable storage units and interfaces that allow software and data to be transferred from the removable storage unit 914 to the computing system 900.

The computing system 900 may also include a communications interface 918. The communications interface 918 may be used to allow software and data to be transferred between the computing system 900 and external devices. Examples of the communications interface 918 may include a network interface (such as an Ethernet or other NIC card), a communications port (such as for example, a USB port, a micro USB port), Near field Communication (NFC), etc. Software and data transferred via the communications interface 918 are in the form of signals which may be electronic, electromagnetic, optical, or other signals capable of being received by the communications interface 918. These signals are provided to the communications interface 918 via a channel 920. The channel 920 may carry signals and may be implemented using a wireless medium, wire or cable, fiber optics, or other communications medium. Some examples of the channel 920 may include a phone line, a cellular phone link, an RF link, a Bluetooth link, a network interface, a local or wide area network, and other communications channels.

The computing system 900 may further include Input/Output (I/O) devices 922. Examples may include, but are not limited to a display, keypad, microphone, audio speakers, vibrating motor, LED lights, etc. The I/O devices 922 may receive input from a user and also display an output of the computation performed by the processor 902. In this document, the terms “computer program product” and “computer-readable medium” may be used generally to refer to media such as, for example, the memory 906, the storage devices 908, the removable storage unit 914, or signal(s) on the channel 920. These and other forms of computer-readable media may be involved in providing one or more sequences of one or more instructions to the processor 902 for execution. Such instructions, generally referred to as “computer program code” (which may be grouped in the form of computer programs or other groupings), when executed, enable the computing system 900 to perform features or functions of embodiments of the present invention.

In an embodiment where the elements are implemented using software, the software may be stored in a computer-readable medium and loaded into the computing system 900 using, for example, the removable storage unit 914, the media drive 910 or the communications interface 918. The control logic (in this example, software instructions or computer program code), when executed by the processor 902, causes the processor 902 to perform the functions of the invention as described herein.

In short, in some embodiments, a visitor may be provided with credentials while entering a closed premises valid for only a certain period. With the credentials, the visitor may be able to login into a mobile application, or a browser based application of indoor navigation system of the closed premises. Once the visitor provides a destination, that information along with the information collected at entrance through the cameras may be sent to the database. Further, a minimal path to the destination may be sent to the visitor's mobile application/browser based application. The information such as the minimal path may only be sent to the valid visitor. The valid visitor is a visitor who login into the application successfully by providing the credentials.

Thus, the present disclosure may overcome drawbacks of traditional systems discussed before. The present disclosure identifies a current location with high accuracy without compromising the security. The disclosure requires minimum infrastructure cost as the system can be implemented using existing cameras. In other words, the existing cameras are enough for implementing the system. The disclosure provides enhanced security as the visitor's data may be stored in the form of hash values. For example, when a person enters the closed premises, the data corresponding to that person may be stored in a form of hash value (i.e., in an encrypted format). For identifying if the person is new person visiting the closed premises for the first time or an existing person visited the closed promises earlier, the only way is to match the hash values. It is impossible to recover original data from the hash value. However, it can be used for the comparison purpose to check whether the same person visited the facility. Additionally, the disclosure may be used to locate the assets with high accuracy level. Further, the cameras are tagged with the location coordinate tags of the static objects. Thus, the exact distance between the objects, and/or the locations may be determined. This may further help in identifying the exact current location of visitors.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of identifying a current location of a user in a closed premises, the method comprising:
capturing, by a server via at least one camera communicatively coupled to the server, user information associated with the user and object information associated with one or more static objects in proximity to the user, when the user and the one or more static objects are within a Field of View (FOV) of the at least one camera, wherein the user information comprises primary user data and secondary user data, and wherein the primary user data is stored in a form of hash value;
comparing, by the server, the user information with historical user information corresponding a plurality of users visited the closed premises, and the object information with historical object information corresponding to a plurality of static objects within the closed premises; and
identifying, by the server, the current location of the user within the closed premises based on the comparing.

2. The method of claim 1, further comprising receiving a user input related to a destination location from the user, upon a successful user authentication.

3. The method of claim 2, further comprising:
determining an optimal route from a plurality of routes based on the current location of the user, the destination location, and the user information; and
providing recommendations to the user for navigating inside the closed premises to reach the destination location based on the optimal route.

4. The method of claim 1, further comprising:
assigning location coordinate tags of static objects to corresponding cameras for each location of a plurality of locations within the closed premises.

5. The method of claim 3, further comprising:
dynamically capturing motion of the user while the user starts navigating on the optimal route, wherein the motion of the user during the navigation is captured via each of a set of cameras along the optimal route; and
validating whether the motion of the user is on the optimal route.

6. The method of claim 5, further comprising:
determining a new optimal route when the validation is unsuccessful; and
rendering new recommendations based on the new optimal route to the user for navigation to the destination location inside the closed premises.

7. The method of claim 1, further comprising:
determining the hash value corresponding to the primary user data;
comparing the hash value with a plurality of historical hash values corresponding to primary user data of the plurality of users visited the closed premises; and
at least one of:
identifying the user as an existing user when the hash value is equivalent to at least one hash value of the plurality of historical hash values; or
identifying the user as a new user when the hash value is different from each of the plurality of historical hash values.

8. The method of claim 1, wherein the primary user data is corresponding to a plurality of constant user attributes and the secondary user data is corresponding to a plurality of variable user attributes.

9. A system for identifying a current location of a user in a closed premises, the system comprising:
a processor; and
a memory communicatively coupled to the processor, wherein the memory stores processor-executable instructions, which, on execution, cause the processor to:
capture, via at least one camera, user information associated with the user and object information associated with one or more static objects in proximity to the user, when the user and the one or more static objects are within a Field of View (FOV) of the at least one camera, wherein the user information comprises primary user data and secondary user data, and wherein the primary user data is stored in a form of hash value;
compare the user information with historical user information corresponding a plurality of users visited the closed premises, and the object information with historical object information corresponding to a plurality of static objects within the closed premises; and
identify the current location of the user within the closed premises based on the comparing.

10. The system of claim 9, wherein the processor-executable instructions further cause the processor to receive a user input related to a destination location from the user, upon a successful user authentication.

11. The system of claim 10, wherein the processor-executable instructions further cause the processor to:
determine an optimal route from a plurality of routes based on the current location of the user, the destination location, and the user information; and
provide recommendations to the user for navigating inside the closed premises to reach the destination location based on the optimal route.

12. The system of claim 9, wherein the processor-executable instructions further cause the processor to:
assign location coordinate tags of static objects to corresponding cameras for each location of a plurality of locations within the closed premises.

13. The system of claim 11, wherein the processor-executable instructions further cause the processor to:
dynamically capture motion of the user while the user starts navigating on the optimal route, wherein the motion of the user during the navigation is captured via each of a set of cameras along the optimal route; and
validate whether the motion of the user is on the optimal route.

14. The system of claim 13, wherein the processor-executable instructions further cause the processor to:
determine a new optimal route when the validation is unsuccessful; and
render new recommendations based on the new optimal route to the user for navigation to the destination location inside the closed premises.

15. The system of claim 9, wherein the processor-executable instructions further cause the processor to:
determine the hash value corresponding to the primary user data;
compare the hash value with a plurality of historical hash values corresponding to primary user data of the plurality of users visited the closed premises; and
at least one of:
identify the user as an existing user when the hash value is equivalent to at least one hash value of the plurality of historical hash values; or
identify the user as a new user when the hash value is different from each of the plurality of historical hash values.

16. The system of claim 9, wherein the primary user data is corresponding to a plurality of constant user attributes and the secondary user data is corresponding to a plurality of variable user attributes.

17. A non-transitory computer-readable medium storing computer-executable instructions for identifying a current location of a user in a closed premises, the computer-executable instructions configured for:
capturing, via at least one camera, user information associated with the user and object information associated with one or more static objects in proximity to the user, when the user and the one or more static objects are within a Field of View (FOV) of the at least one camera, wherein the user information comprises primary user data and secondary user data, and wherein the primary user data is stored in a form of hash value;
comparing the user information with historical user information corresponding a plurality of users visited the closed premises, and the object information with historical object information corresponding to a plurality of static objects within the closed premises; and
identifying the current location of the user within the closed premises based on the comparing.

18. The non-transitory computer-readable medium of the claim 17, wherein the computer-executable instructions further configured for receiving a user input related to a destination location from the user, upon a successful user authentication.

19. The non-transitory computer-readable medium of the claim 18, wherein the computer-executable instructions further configured for:
determining an optimal route from a plurality of routes based on the current location of the user, the destination location, and the user information; and
providing recommendations to the user for navigating inside the closed premises to reach the destination location based on the optimal route.

20. The non-transitory computer-readable medium of the claim 17, wherein the computer-executable instructions further configured for assigning location coordinate tags of static objects to corresponding cameras for each location of a plurality of locations within the closed premises.
